(19) United States
(12) Patent Application Publication
(10) Pub. No.: US 2011/0272512 A1
(43) Pub. Date: Nov. 10, 2011

(54) Roller Mill

(75) Inventors: Jan Folsberg, Roskilde (DK); Rainer Closter Jespersen, Kgs. Lyngby (DK)

(73) Assignee: FLSMIDTH A/S, Valby (DK)

(21) Appl. No.: 13/143,995

(22) PCT Filed: Jan. 26, 2010
(86) PCT No.: PCT/IB2010/050339

§ 371 Date: Jul. 11, 2011

(30) Foreign Application Priority Data
Jan. 30, 2009 (DK) PA 2009 00138

(51) Int. Cl. B02C 11/00

(52) U.S. Cl. 241/101.2

(57) ABSTRACT

A roller mill for grinding particulate material comprises a grinding table which by means of a drive mechanism is rotatable about a vertical axis, at least one roller rotatably mounted on a shaft and being maintained in tangential direction relative to the grinding table by means of a guide mechanism and a support. The roller mill also comprises a vibration-compensating device that is arranged in connection with the guide mechanism to ensure in interaction therewith that the roller is maintained in tangential direction relative to the grinding table.

### CROSS REFERENCE TO RELATED APPLICATION

This application is the United States national stage under 35 U.S.C. §371 of International Application No. PCT/IB2010/050339, filed on Jan. 26, 2010, which claimed priority to Danish Patent Application No. PA 2009 00138, filed on Jan. 30, 2009. The entirety of these applications is incorporated by reference herein.

### FIELD OF THE INVENTION

The present invention relates to a roller mill for grinding particulate material such as cement raw materials, cement clinker and similar materials, said roller mill comprising a grinding table which by means of a drive mechanism is rotatable about a vertical axis, at least one roller which is rotatably mounted on a shaft and being maintained in tangential direction relative to the grinding table by means of a guide mechanism and a support.

### BACKGROUND OF THE INVENTION

Roller mills of the aforementioned kind are generally known. During operation, the drive mechanism of the roller mill is quite often exposed to substantial loads which will reduce its service life, and which are ascribable to major variations in the torsional moment which often appear as high-frequency variations in the torsional moment. These variations in the torsional moment relate primarily to the flexibility in the mill drive mechanism and furthermore to the flexibility of the support of the guide mechanism which is often constituted by the frame or housing of the mill, and originating for example from variations in the tangential force imposed on the roller due to changes in the operating environment, such as changes in the grinding bed thickness etc. This flexibility in the guide mechanism support will enable the roller to move tangentially relative to the grinding table during the operation of the mill, leading to increased variation in the torsional moment of the drive mechanism due to the thereby existing mass and spring oscillation system.

### SUMMARY OF THE INVENTION

It is the objective of the present invention to provide a roller mill by means of which the aforementioned disadvantage is eliminated or at least substantially reduced.

This is obtained by means of a roller mill of the kind mentioned in the introduction and being characterized in that it comprises a vibration-compensating device which is arranged in connection with the guide mechanism to ensure in interaction therewith that the roller is maintained in tangential direction relative to the grinding table.

It is hereby obtained that the roller is maintained in tangential direction relative to the grinding table independently of the flexibility of the guide mechanism support, so that the variations in the torsional moment of the mill drive mechanism and hence the loads on the drive mechanism are reduced. This is due to the fact that the vibration-compensation mechanism equalizes the elastic movement affecting the guide mechanism support when the tangential force, which is to be absorbed via the guide mechanism, varies due to a change in the operating environment, thereby actively preventing the roller from moving tangentially relative to the grinding table.

The vibration-compensating device may in principle be any suitable device compensating for vibrations. In one embodiment the vibration-compensating device may thus comprise a so-called active vibration damper (AVD).

In order to minimize the amount of energy which is lost, the vibration-compensating device should preferably function as a spring moving in counterphase with the tangential load imposed on the guide mechanism support, and hence the elastic movement of the guide mechanism.

The vibration-compensating device may comprise electrical as well as mechanical and hydraulic components and may be controlled for example by means of a measuring device indicating the absolute tangential position of the roller relative to the grinding table, or alternatively using a measuring device indicating the tangential force which is transferred via the guide mechanism or through the hydraulic pressure in hydraulic components such as hydraulic cylinders.

The guide mechanism of the roller mill may be constituted by any suitable guide mechanism. In one embodiment the guide mechanism may comprise a tangential arm which at its respective ends is rotatably connected to the shaft and the support, respectively, whereas in a second embodiment it may comprise a frame structure in which the rollers are suspended. The frame structure may include a housing of the roller mill.

Other details, objects, and advantages of the invention will become apparent as the following description of certain present preferred embodiments thereof and certain present preferred methods of practicing the same proceeds.

### BRIEF DESCRIPTION OF THE DRAWINGS

The invention will now be explained in further details with reference to the drawing, being diagrammatical, and where

FIG. 1 shows a side view of a first embodiment of the roller mill according to the invention, and

FIG. 2 shows a top view of the first embodiment of the roller mill.

### DETAILED DESCRIPTION OF PRESENT PREFERRED EMBODIMENTS

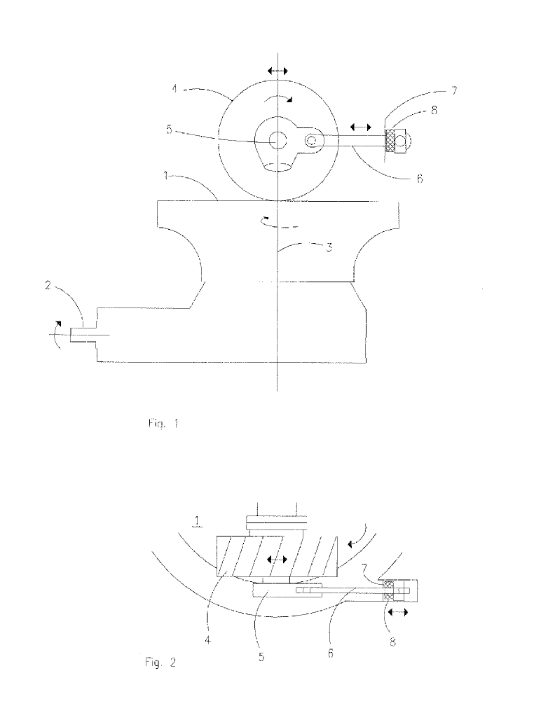

FIGS. 1 and 2 show a roller mill comprising a grinding table 1, which by means of a drive mechanism 2 is rotatable about a vertical axis 3, a roller 4, which is rotatably mounted on a shaft 5, and being maintained in tangential direction relative to the grinding table by means of a tangential arm 6 which at its respective ends is rotatably connected to the shaft 5 and a support 7, respectively.

In order to maintain the roller 4 in tangential direction relative to the grinding table 1 independently of the flexibility of the support 7 of the tangential arm, the roller mill comprises a vibration-compensating device 8 which is arranged so in connection with the tangential arm 6 that the vibration-compensating device 8 will equalize the elastic movement affecting the support 7 of the tangential arm 6 when the tangential force, which is to be absorbed via the tangential arm 6, varies due to a change in the operating environment. This will ensure that the roller does not move tangentially relative to the grinding table, and therefore does not contribute significantly to the variations in the torsional moment of the mill drive mechanism.

It is hereby obtained that the roller 4 is maintained in tangential direction relative to the grinding table 1 independently of the flexibility of the guide mechanism support so that the variations in the torsional moment of the mill drive mechanism and hence the wear on the drive mechanism are reduced. This is due to the fact that the vibration-compensation mechanism equalizes the elastic movement affecting the guide mechanism support when the tangential force, which is to be absorbed via the guide mechanism, varies due to a change in the operating environment, thereby actively preventing the roller 4 from moving tangentially relative to the grinding table. In one embodiment the vibration-compensating device 8 may comprise a so-called active vibration damper (AVD).

While certain present preferred embodiments of the roller mill and certain embodiments of methods of practicing the same have been shown and described, it is to be distinctly understood that the invention is not limited thereto but may be otherwise variously embodied and practiced within the scope of the following claims.

1. A roller mill comprising:
a drive mechanism;
a grinding table that is rotatable about a vertical axis via the drive mechanism;
a shaft:
a support;
at least one roller rotatably mounted on the shaft and being maintained in tangential direction relative to the grinding table by means of a guide mechanism and the support;
a vibration-compensating device arranged in connection with the guide mechanism to ensure an interaction therewith so that the at least one roller is maintained in tangential direction relative to the grinding table.

2. The roller mill of claim 1 wherein the vibration-compensating device comprises an active vibration damper (AVD).

3. The roller mill of claim 1 wherein the vibration-compensating device functions as a spring which is moving in counter-phase with the tangential load affecting the guide mechanism support and hence the elastic movement of the support.

4. The roller mill of claim 1 wherein the vibration-compensating device comprises electrical, mechanical and/or hydraulic components.

5. The roller mill of claim 1 further comprising a measuring device indicating an absolute tangential position of the at least one roller relative to the grinding table.

6. The roller mill of claim 1 further comprising a measuring device indicating tangential force transmitted via the guide mechanism.

7. The roller mill of claim 1 wherein hydraulic pressure in hydraulic components is utilized for controlling the vibration-compensating device.

8. The roller mill of claim 1 wherein the guide mechanism comprises a tangential arm having a first end rotatably connected to the shaft and a second end opposite the first end rotatably connected to the support.

9. The roller mill of claim 1 wherein the support comprises a housing of the roller mill.

10. A roller mill comprising:
a rotatable grinding table;
a shaft;
at least one roller rotatably mounted on the shaft such that the at least one roller is positionable over the grinding table to grind material positioned on the grinding table;
a guide mechanism;
a support; and
a vibration compensating device arranged in connection with the guide mechanism to interact with the guide mechanism so that the at least one roller is prevented from moving tangentially relative to the grinding table.

11. The roller mill of claim 10 wherein the guide mechanism has a first end and a second end opposite the first end, the first end being connected to the shaft and the second end being connected to the support.

12. The roller mill of claim 11 wherein the first end is rotatably connected to the shaft and the second end is rotatably connected to the support.

13. The roller mill of claim 12 wherein the guide mechanism is an arm.

14. The roller mill of claim 11 wherein the guide mechanism is connected to the vibration compensating device such that the vibration compensating device equalizes elastic movement affecting the support when tangential force absorbed by the guide mechanism varies due to a change in torsional moment.

15. The roller mill of claim 10 wherein the vibration compensating device comprises an active vibration damper.

16. The roller mill of claim 10 further comprising a measuring device indicating at least one of a tangential force which is transmitted via the guide mechanism and an absolute tangential position of the at least one roller relative to the grinding table.

17. The roller mill of claim 10 wherein the vibration compensating device functions as a spring moving in counter-phase with tangential load affecting the guide mechanism support.

18. The roller mill of claim 10 wherein hydraulic pressure in at least one hydraulic component is utilized for controlling the vibration compensating device.

19. The roller mill of claim 10 further comprising a drive mechanism attached to the grinding table to drive rotation of the grinding table about a vertical axis.

20. The roller mill of claim 10 wherein the vibration compensating device is connected to at least one of the support and the guide mechanism.
